(19) United States
(12) Patent Application Publication
(10) Pub. No.: US 2019/0370710 A1
(43) Pub. Date: Dec. 5, 2019

(54) CONTEXTUAL DATA PROCESSING AND DATA DISTRIBUTION

(71) Applicant: Accenture Global Solutions Limited, Dublin (IE)

(72) Inventors: Christian Romer Pedrosa MACANDOG, Manila (PH); Jason WARNKE, Tampa, FL (US); Thomas Anthony PARISI, Naperville, IL (US); Marcianne Reaksecker JENKINS, Denver, CO (US); Russell MAIDMENT, Dublin (IE); Marjorie Jo DUKE, Friendswood, TX (US); Clare Maria TIERNEY, Dublin (IE); Janet Leigh SMITH, Holmes Beach, FL (US); Steven Ronald BOROWSKI, Chicago, IL (US); David F. SCHNEIDERMAN, Beverly Hills, CA (US)

(21) Appl. No.: 16/426,637

(22) Filed: May 30, 2019

Related U.S. Application Data
(60) Provisional application No. 62/678,630, filed on May 31, 2018.

(51) Int. Cl. G06Q 10/06; G07C 9/00

(52) U.S. Cl. CPC G06Q 10/06311; G07C 9/00071

(57) ABSTRACT

A device may receive, from a user device, information identifying a location of the user device. The device may determine, based on the information identifying the location, a facility associated with the location or a facility area within the facility. The device may determine one or more first tasks associated with the facility or one or more second tasks associated with the facility area. The device may transmit, to the user device, information identifying the one or more first tasks or the one or more second tasks. The device may receive, from the user device, a request to perform a task of the one or more first tasks or the one or more second tasks. The device may perform one or more actions relating to the task to produce information associated with the task. The device may transmit, to the user device, the information associated with the task.

### RELATED APPLICATION

This application claims priority under 35 U.S.C. § 119 to U.S. Provisional Patent Application No. 62/678,630, filed on May 31, 2018, the content of which is incorporated by reference herein in its entirety.

### BACKGROUND

Users sometimes interact with applications (e.g., applications of user devices, such as smart phones) to perform various tasks and/or to obtain information.

### SUMMARY

According to some implementations, a method may include receiving, by a device and from a user device, information identifying a location of the user device, wherein the user device is associated with a user. The method may include determining, by the device and based on the information identifying the location, one or more of: a facility associated with the location, or a facility area within the facility. The method may include determining, by the device, one or more first tasks associated with the facility or one or more second tasks associated with the facility area. The method may include transmitting, by the device and to the user device, information identifying the one or more first tasks or the one or more second tasks. The method may include receiving, by the device and from the user device, a request to perform a task, wherein the task is one of the one or more first tasks or the one or more second tasks. The method may include performing, by the device, one or more actions relating to the task of the request, wherein the one or more actions produce information associated with the task. The method may include transmitting, by the device and to the user device, the information associated with the task to permit the user to complete the task.

According to some implementations, a device may include one or more memories, and one or more processors, communicatively coupled to the one or more memories, to receive, from a user device, information identifying a location of the user device, wherein the user device is associated with a user. The one or more processors may determine, based on the information identifying the location, one or more of: a facility associated with the location, or a facility area within the facility. The one or more processors may determine one or more first tasks associated with the facility or one or more second tasks associated with the facility area. The one or more processors may determine one or more tasks that are to be performed for the user, wherein the one or more tasks are selected from the one or more first tasks or the one or more second tasks, wherein the one or more tasks are determined based on historical data relating to a behavior of the user in connection with at least one of the facility or the facility area. The one or more processors may perform the one or more tasks.

According to some implementations, a non-transitory computer-readable medium may store one or more instructions, that when executed by one or more processors of a device, may cause the one or more processors to receive, from a user device, information identifying a location of the user device, wherein the user device is associated with a user. The one or more instructions may cause the one or more processors to determine, based on the information identifying the location, one or more of: a facility associated with the location, or a facility area within the facility. The one or more instructions may cause the one or more processors to determine one or more first tasks associated with the facility or one or more second tasks associated with the facility area. The one or more instructions may cause the one or more processors to transmit, to the user device, information identifying the one or more first tasks or the one or more second tasks; receive, from the user device, a request to perform a task, wherein the task is one of the one or more first tasks or the one or more second tasks. The one or more instructions may cause the one or more processors to perform the task of the request. The one or more instructions may cause the one or more processors to transmit, to the user device, information relating to a performance of the task.

### BRIEF DESCRIPTION OF THE DRAWINGS

FIGS. 1A-1C are diagrams of one or more example implementations described herein.

FIG. 2 is a diagram of an example environment in which systems and/or methods described herein may be implemented.

FIG. 3 is a diagram of example components of one or more devices of FIG. 2.

FIGS. 4-6 are flow charts of example processes for contextual data processing and data distribution.

### DETAILED DESCRIPTION

The following detailed description of example implementations refers to the accompanying drawings. The same reference numbers in different drawings may identify the same or similar elements.

As data generated by an organization increases to millions, billions, or tens of billions of data entries, users may become unable to access data relevant to particular use cases. Disparate applications may be provided to attempt to organize data entries and provide relevant information to users, however, users may be unable to determine which application includes relevant information, controls relevant information, controls relevant systems, and/or the like. The user may access multiple applications to determine which application includes relevant information, controls relevant information, controls relevant systems, and/or the like. However, such manual application access results in excess utilization of power resources, network resources, processing resources, and/or the like. Moreover, utilization of resources may increase dramatically as a quantity of data entries associated with an organization increases as a result of inefficient access of the data entries by users.

Some implementations described herein provide a unified organizational management platform to perform data processing and data distribution for an organization. For example, the organizational management platform may obtain information regarding the organization, regarding users, regarding locations relating to the organization, and/or the like, and may provide context aware user interface views, thereby obviating a need for multiple applications to be stored on a user device. In this case, the organizational management platform may provide context aware user interfaces based on a location of a user, a preference of a user, and/or the like. Moreover, based on using machine learning, natural language processing, and/or the like, some implementations described herein may automatically perform tasks for a user, obtain and provide information for the user, and/or the like, thereby reducing a utilization of resources (e.g., power resources, network resources, processing resources, and/or the like) relative to manual information retrieval and task fulfillment. For example, the organizational management platform may automatically adjust environmental settings of a room for a user, transmit alerts to and/or for the user, obtain reservations for the user, and/or the like.

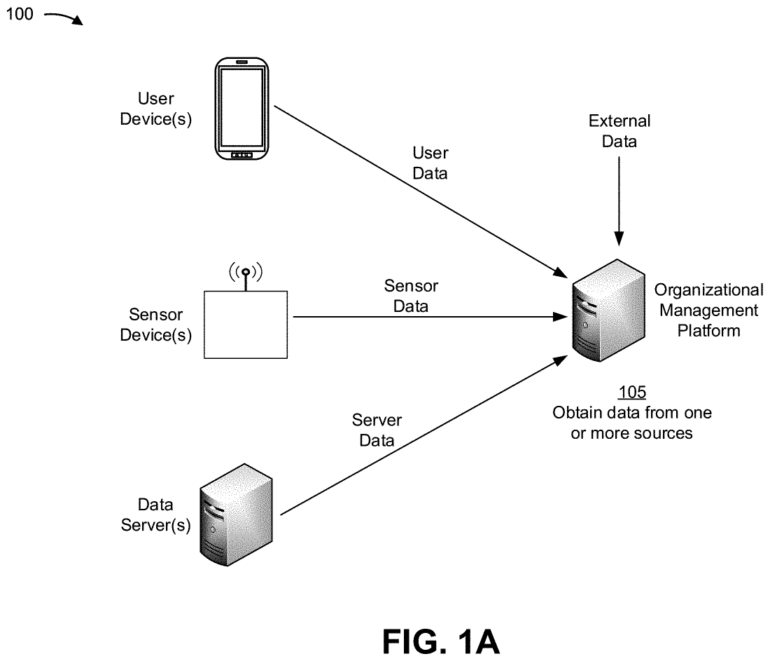

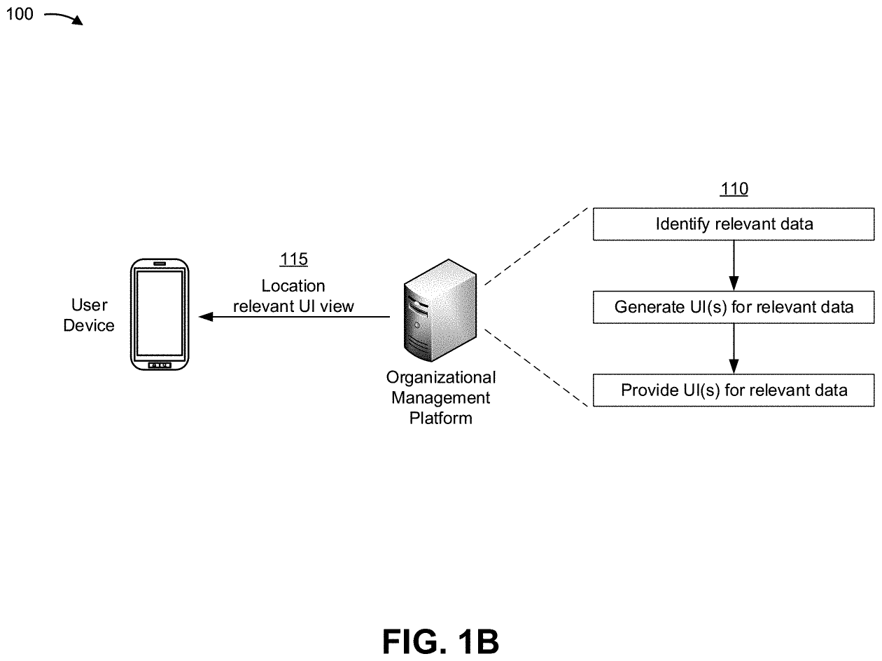

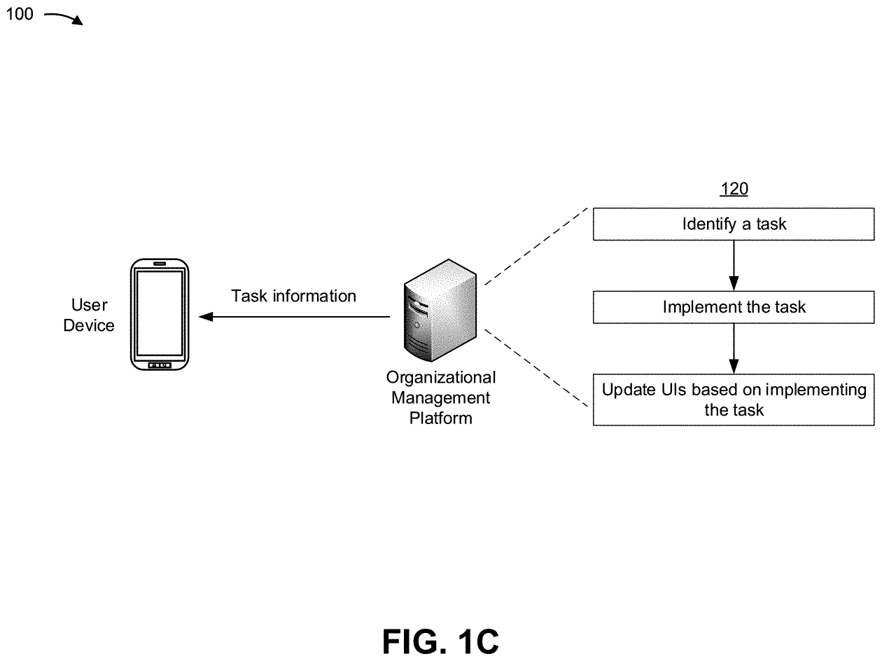

FIGS. 1A-1C are diagrams of an example implementation 100 described herein. As shown in FIG. 1A, example implementation 100 includes an organizational management platform, one or more user devices, one or more sensor devices, one or more data servers, and/or the like.

The organizational management platform may be associated with an organization, such as an enterprise (e.g., a business enterprise) having one or more facilities (e.g., office locations in multiple cities, multiple states, or multiple countries). A facility may include one or more co-located buildings of an organization as well as parking areas (e.g., parking lots, parking garages, and/or the like) associated with the buildings and/or outdoor areas associated with the buildings.

The one or more user devices may be associated with individuals that are associated with the organization (e.g., employees of the organization, customers of the organization, clients of the organization, and/or the like). The one or more sensor devices may be associated with the one or more facilities of the organization (e.g., placed in the facilities, installed in the facilities, and/or the like). The one or more sensors devices may relate to temperature sensors, light sensors, motion sensors, and/or the like. The one or more data servers may be associated with the organization and may store and/or provide information relating to the organization (e.g., information relating to employees of the organization, customers of the organization, clients of the organization, facilities of the organization, and/or the like). In some implementations, the one or more data servers may implement (e.g., host) a platform (e.g., a web platform) that performs content administration and task configuration to provide modularity and/or customization of user experience.

While the description to follow will be described in terms of an example of an enterprise having one or more office locations, the description is not limited to this particular example. Implementations described herein also apply to other organization and/or facilities that may use a unified organizational management platform, such as a hotel, an airport, a school, and/or the like.

As shown in FIG. 1A, and by reference number 105, the organization management platform may obtain data (e.g., from one or more data sources). For example, the organizational management platform may obtain user data from the user device, such as data identifying a user of the user device, a location of the user, a user interaction with a user interface of the user device, and/or the like. Additionally, or alternatively, the organizational management platform may receive sensor data identifying a sensor measurement by a sensor device. For example, the organizational management platform may receive sensor data indicating whether a facility area (e.g., a room) in a facility is in use, indicating a location of a user, indicating a brightness of a light in the facility, indicating a temperature in the facility, and/or the like. Additionally, or alternatively, the organizational management platform may receive server data from the one or more data servers. For example, the organizational management platform may receive server data identifying an event associated with the organization, a project status of a project, an employee list for the organization, and/or the like. Additionally, or alternatively, the organizational management platform may receive external data relating to an external entity (e.g., from another data server). For example, the organizational management platform may receive data identifying a flight schedule, a restaurant reservation availability, a car service availability, a set of attractions for a geographic area, and/or the like.

As shown in FIG. 1B, and by reference number 110, the organizational management platform may process the received data. For example, the organizational management platform may identify relevant data for a user of the user device, generate one or more user interfaces for the relevant data, and may provide the one or more user interfaces for display via the user device.

In some implementations, the organizational management platform may determine a set of hierarchical places based on a location (e.g., based on global positioning system (GPS) data) of the user device. For example, based on the location of the user device, the organizational management platform may determine a facility (e.g., a building, such as an office) associated with the location, a geographic area (e.g., a neighborhood, a city, a county, and/or the like) that contains the facility, and/or a facility area (e.g., a room of the facility or a plurality of rooms of the facility, a workspace of the facility or a plurality of workspaces of the facility, and/or the like) within the facility.

The organizational management platform may determine tasks (e.g., actions) that may be performed for the user, or by the user, based on the facility, the geographic area, and/or the facility area that is determined. For example, the organizational management platform may determine one or more tasks associated with the facility, one or more tasks associated with the geographic area, and/or one or more tasks associated with the facility area. The one or more tasks associated with the facility may include tasks that are particular to the facility (e.g., tasks associated with a first facility may be different than tasks associated with a second facility). The one or more tasks associated with the geographic area may include tasks that are particular to the geographic area (e.g., tasks associated with a first geographic area (e.g., a first city) may be different than tasks associated with a second geographic area (e.g., a second city)). The one or more tasks associated with the facility area may include tasks that are particular to the facility area (e.g., tasks associated with a first facility area (e.g., a first room of a facility) may be different than tasks associated with a second facility area (e.g., a second room of a facility)). In this way, the organizational management platform may provide task-related options that are particular to a location of a user.

Tasks associated with a facility may relate to generating a credential to access a secure location of the facility, initiating a support request relating to a service of the facility, locating an individual within the facility, and/or the like. Tasks associated with a geographic area may relate to reserving transportation in the geographic area, reserving accommodations in the geographic area, reserving access to an event in the geographic area, and/or the like. Tasks associated with a facility area may relate to reserving the facility area, generating instructions for locating the facility area, adjusting an environmental setting of the facility area, initiating a support request relating to a service of the facility area, and/or the like.

In some implementations, the organizational management platform may determine information for the user based on the facility, the geographic area, and/or the facility area that is determined. For example, the organizational management platform may determine information associated with the facility, information associated with the geographic area, and/or information associated with the facility area. The information associated with the facility may include information that is particular to the facility. For example, the information may relate to a map of the facility, amenities of the facility, events at the facility, messages or notifications relating to the facility, and/or the like. The information associated with the geographic area may include information that is particular to the geographic area. For example, the information may relate to a map of the geographic area, attractions of the geographic area, events of the geographic area, environmental conditions of the geographic area, and/or the like. The information associated with the facility area may include information that is particular to the facility area. For example, the information may include a map to the facility area, features of the facility area, amenities of the facility area, environmental conditions of the facility area, messages or notifications relating to the facility area, and/or the like.

In some implementations, the organizational management platform may provide event information. For example, the organizational management platform may determine and provide information identifying events of relevance to a user based on a location of the user, a preference of the user, and/or the like. In some implementations, the organizational management platform may provide information identifying an event in a city of the user, restaurant reservation information for the user, airport information for the user, and/or the like.

In some implementations, the organizational management platform may identify (e.g., automatically identify) the relevant data (e.g., tasks and/or information) using a machine learning technique. For example, the organizational management platform may obtain numerous data entries, requests for data by users, and/or the like, and may generate a model of data relevance based on a user's identity, a user's location, a user's preferences, and/or the like. In this case, the organizational management platform may use the model of data relevance to automatically determine a subset of data to provide to the user, thereby reducing utilization of network resources relative to manual access by the user to attempt to locate relevant data. For example, the organizational management platform may use the model of data relevance to determine one or more particular tasks to provide to the user and/or one or more particular items of information to provide to the user based on the user's identity, the user's location, the user's preferences, and/or the like.

In some implementations, the organizational management platform may generate a user interface based on a set of hierarchical places. In some implementations, the organizational management platform may identify a hierarchical view level for a user interface for a user (e.g., based on a set of hierarchical places). For example, the organizational management platform may determine a facility area (e.g., a room) level for a user interface, and may provide information and/or tasks associated with a particular facility area that the user is in, to which the user is going to travel, and/or the like. Additionally, or alternatively, the organizational management platform may determine a facility level for a user interface, and may provide information and/or tasks associated with a particular facility that the user is in, to which the user is going to travel, and/or the like. Additionally, or alternatively, the organizational management platform may determine a geographic area (e.g., a city) level for a user interface, and may provide information and/or tasks associated with a particular geographic area that the user is in, to which the user is going to travel, and/or the like. Additionally, or alternatively, the organizational management platform may determine another type of level.

In some implementations, the organizational management platform may determine a subject type for the user interface. For example, the organizational management platform may determine a movement type (e.g., wayfinding information and/or tasks provided via an augmented reality user interface), an access and authentication type (e.g., a user interface for providing authentication credentials to access information, to access a room, and/or the like), a facility type (e.g., a user interface for providing information and/or tasks regarding a facility, such as events at the facility, configuration of environmental settings at the facility, and/or the like), a social and collaboration type (e.g., a user interface for providing information and/or tasks relating to user interaction between users associated with a common room, facility, event, project, and/or the like), and/or the like for the user interface. In this case, at each view level, the organizational management platform may provide different information and/or tasks for each subject type. For example, at a facility area (e.g. a room) level and social and collaboration type, the user interface may include information identifying messages from users in a particular facility area (e.g., a particular room), and at a facility level and social and collaboration type, the user interface may include information identifying messages from users in a facility. As another example, at a facility area level and access and authentication type, the user interface may include a task for generating a credential to access a facility area, and at a facility level and access and authentication type, the user interface may include a task for generating a credential to access a facility.

In some implementations, the organizational management platform may divide a user interface into multiple information modules. For example, the organizational management platform may provide a view change module, a first data module, a second data module, a third data module, and/or the like. In this case, the organizational management platform may order the data modules based on a user preference, a relevance determination, and/or the like.

As shown by reference number 115, the organizational management platform may transmit one or more location-relevant user interface views to the user device and/or transmit information to the user device to thereby cause the user device to display one or more location-relevant user interface views. In some implementations, a first user interface view may identify tasks and/or information associated with a facility, a second user interface view may identify tasks and/or information associated with a geographic area that contains the facility, and a third user interface view may identify tasks and/or information associated with a facility area within the facility.

As shown in FIG. 1C, and by reference number 120, the organizational management platform may identify a task, implement the task, and update one or more user interfaces based on implementing the task (or transmit information to the user device to thereby cause the user device to update the one or more user interfaces).

In some implementations, the organizational management platform may identify a task based on a request from the user device. For example, the organizational management platform may receive, from the user device, a request to perform a task. The user device may request that the organizational management platform perform a task from the one or more tasks associated with the facility, the one or more tasks associated with the geographic area, and/or the one or more tasks associated with the facility area determined by the organizational management platform.

In some implementations, the organizational management platform may implement the task identified by performing the task. In addition, the organizational management platform may transmit information associated with a performance of the task to cause the user device to update a user interface view. For example, if the task is to initiate a support request relating to a service of the facility, the organizational management platform may identify an issue relating to the facility (e.g., based on information provided by the user device), determine a location (e.g., a building, a floor, a room number, and/or the like) of the user or the issue (e.g., based on a location of the user device), generate a support ticket relating to the issue, and transmit the support ticket to an appropriate technical support provider (e.g., based on the issue). Continuing with the previous example, the organizational management platform may transmit, to the user device, information associated with a performance of the task, such as a confirmation that support was requested, information relating to the support request, a recommendation of one or more remedial actions that the user may attempt while the support request is pending, and/or the like.

In some implementations, the organizational management platform may implement the task identified by performing one or more actions based on the request to thereby produce information associated with the task. The organizational management platform may transmit the information to the user device to cause the user device to update a user interface view. The updated user interface view may permit a user of the user device to complete the task. For example, if the task is to access a secure location of the facility, the organizational management platform may perform one or more actions based on the task, such as determining an authorization of the user based on an identity of the user and generating a credential that permits the user to access the secure location. Continuing with the previous example, the organizational management platform may transmit the credential to the user device to cause an updated user interface view (e.g., an updated user interface view that displays the credential), which permits the user to complete the task (e.g., by accessing the secure area using the credential).

In some implementations, the organizational management platform may update one or more user interfaces (e.g., a user interface associated with a facility, a geographic area, and/or a facility area) based on implementing the task. For example, if the organizational management platform reserves a particular facility area (e.g., a room) for a user, the organizational management platform may update a user interface relating to a facility area with information relating to the particular facility area, such as features of the particular facility area, tasks associated with the particular facility area (e.g., adjusting an environmental setting), a duration for which the user may occupy the particular facility area, and/or the like.

In some implementations, the organizational management platform may automatically identify a task, automatically implement the task, and automatically update one or more user interfaces based on implementing the task (or transmit information to the user device to thereby cause the user device to update the one or more user interfaces). For example, the organizational management platform may use a machine learning model of task performance to automatically implement a task. For example, the organizational management platform may obtain numerous data entries regarding an organization and tasks associated therewith to automatically identify a task that is to be performed for a user, and complete the task for the user.

The organizational management platform may determine a task to perform for the user from the one or more tasks associated with the facility, the one or more tasks associated with the geographic area, and/or the one or more tasks associated with the facility area determined by the organizational management platform. In some implementations, the organizational management platform may determine the task based on historical data relating to a behavior of the user (e.g., in connection with the facility, the geographic area, and/or the facility area). For example, the organizational management platform may determine to reserve a room for the user because the user previously reserved the room, generate a credential for the user because the user previously visited the facility, adjust an environmental setting of a room based on a previous environmental setting associated with the user, and/or the like. In some implementations, the organizational management platform may determine the task based on historical data relating to behaviors of a plurality of users (e.g., in connection with the facility, the geographic area, and/or the facility area). The plurality of users may share one or more characteristics with the user (e.g., a user of the plurality of users may have a same or a similar role at the organization as the user, a same or a similar schedule as the user, a same or a similar preference as the user, a same or a similar past behavior as the user, and/or the like).

In some implementations, the organizational management platform may interact with an enterprise system to coordinate tasks for a user. For example, the organizational management platform may facilitate requesting of an electronic credential permitting physical access to a facility from an access control system following a user's request to reserve space in that facility. In some implementations, the organizational management platform may, using information from sensor devices, detect that a user has entered a facility and automatically display maps and/or instructions to the user to guide the user to reserved space. Upon detecting that the user has arrived in the requested space, the organizational management platform may cause environmental systems in the space to align to the user's preferences (when a conflict in preferences exists between multiple users, the organizational management platform may cause environmental systems to align to a preference of one of the users (e.g., one of the users having a highest position within the organization)). The organizational management platform may communicate with a reservation system to confirm that the user is actively using the space (i.e., that the user is “checked in”). The organizational management platform may also prompt and/or facilitate the user's use of collaboration devices (e.g., presentation devices) located in the space. The organizational management platform may inform other users of the location of the user so as to facilitate collaboration and/or meetings, or alternatively, delivery of materials. In some implementations, based on information identifying a location of a user (e.g., that the user is delayed in arriving at a reserved space), the organizational management platform may automatically alter a reservation of a space, transmit alerts relating to alteration of the reservation of the space, and/or the like.

In some implementations, the organizational management platform may implement a reservation task. For example, the organizational management platform may determine available facility areas (e.g., workspaces) in a facility, generate information relating to the available facility areas, and transmit the information to the user device to permit a user to reserve or to identify an available facility area. The organizational management platform may determine available facility areas based on sensor data. For example, a workspace may be associated with a sensor (e.g., a motion sensor) that detects whether the workspace is occupied. The information relating to the available facility areas may be presented as a map (e.g., a map of a facility that shows available facility areas by a first indicator and unavailable facility areas by a second indicator).

Additionally, the organizational management platform may automatically implement a reservation task. For example, the organizational management platform may parse a schedule of the user, and may reserve a workspace for the user based on the schedule and/or a user interaction with a user interface.

In some implementations, the organizational management platform may provide a map view of a reserved workspace to enable a user to locate the workspace, reserve the workspace, and/or the like. In some implementations, the organizational management platform may provide an augmented reality navigation view for the reserved workspace.

In some implementations, the organizational management platform may reserve a restaurant reservation, a transportation reservation, an event ticket, and/or the like, automatically or in response to a request by a user. In some implementations, the organizational management platform may provide a support functionality. For example, the organizational management platform may generate a support ticket and dispatch a technical support provider to a location of a user (e.g., based on a location of the user device), automatically or in response to a request by a user. Additionally, or alternatively, the organizational management platform may use a natural language processor and generator to communicate with a user to provide technical support.

In some implementations, the organizational management platform may implement a facility area locating task for a user (e.g., in connection with a reserved workspace). For example, the organizational management platform may monitor a location of the user device in relation to a reserved workspace and generate directional instructions based on the location of the user device in relation to the reserved workspace (e.g., the organizational management platform may update the directional instructions based on changes to the location of the user device in relation to the reserved workspace). In some implementations, the organizational management platform may monitor the location of the user device using one or more beacons located in a facility.

In addition, the organizational management platform may implement a person locating task for the user (e.g., based on a person designated by the user) in a manner similar to the facility area locating task. In some implementations, the organizational management platform may automatically identify a person (e.g., based on a relationship between the user and the person, previous requests of the user to locate the person, previous interactions between the user and the person, such as previously occupying a same workspace, and/or the like) and perform the person locating task. The organizational management platform may permit a person to opt-out of being located by the person locating task and/or permit a person to selectively accept or deny a request to be located.

In some implementations, the organizational management platform may implement a feedback task. For example, the feedback task may relate to rating, or providing feedback on, a facility, a geographic area, or a facility area. The organizational management platform may perform the feedback task by generating an interface in which the user may provide a rating or feedback. In some implementations, the organizational management platform may generate the interface upon detecting that the user has exited a facility, a facility area, or a geographic area. Additionally, or alternatively, the organizational management platform may generate the interface upon detecting that a duration for which the user may occupy a facility or a facility area has expired. In some implementations, the organizational management platform may initiate a support request and/or generate a support ticket based on determining that a rating provided by the user does not satisfy a threshold value (e.g., a 1-star rating) or based on determining that feedback provided by the user is negative (e.g., based on natural language processing of the feedback).

In some implementations, the organizational management platform may implement a credentialing task. For example, the credentialing task may relate to accessing a secure location (e.g., a virtual location containing information, a room, and/or the like) of a facility. The organizational management platform may perform the credentialing task by authenticating the user and generating a credential (e.g., a digital credential) for the user. In some implementations, the organizational management platform may cause a secure area to grant access to an authenticated user (e.g., by unlocking a door to a room).

In this way, the organizational management platform obtains, processes, and distributes data associated with an organization and facilities thereof, thereby reducing a utilization of processing resources, network traffic, and/or the like relative to manual access of data and manual performance of tasks.

As indicated above, FIGS. 1A-1C are provided merely as examples. Other examples are possible and may differ from what is described with regard to FIGS. 1A-1C.

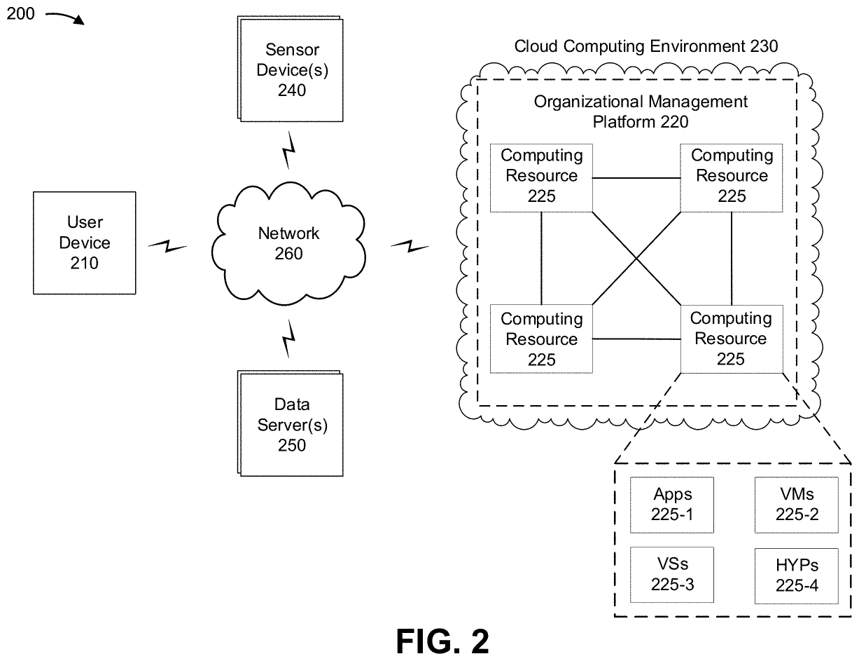

FIG. 2 is a diagram of an example environment 200 in which systems and/or methods described herein may be implemented. As shown in FIG. 2, environment 200 may include a user device 210, an organizational management platform 220, a computing resource 225, a cloud computing environment 230, one or more sensor devices 240, one or more data servers 250, and a network 260. Devices of environment 200 may interconnect via wired connections, wireless connections, or a combination of wired and wireless connections.

User device 210 includes one or more devices capable of receiving, generating, storing, processing, and/or providing information associated with user interface views of data relating to an organization. For example, user device 210 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device.

Organizational management platform 220 includes one or more devices that obtain data, organize data, process data, distribute data, and/or automatically perform tasks relating to data. In some implementations, organizational management platform 220 may generate user interfaces on demand based on a machine learning model of information retrieval to identify relevant information and provide the relevant information for display to a user.

In some implementations, as shown, organizational management platform 220 may be hosted in a cloud computing environment 230. Notably, while implementations described herein describe organizational management platform 220 as being hosted in cloud computing environment 230, in some implementations, organizational management platform 220 may not be cloud-based (i.e., may be implemented outside of a cloud computing environment) or may be partially cloud-based.

Cloud computing environment 230 includes an environment that delivers computing as a service, whereby shared resources, services, etc. may be provided to host organizational management platform 220. Cloud computing environment 230 may provide computation, software, data access, storage, and/or other services that do not require end-user knowledge of a physical location and configuration of a system and/or a device that delivers the services. As shown, cloud computing environment 230 may include organizational management platform 220 and a computing resource 225.

Computing resource 225 includes one or more personal computers, workstation computers, server devices, or another type of computation and/or communication device. In some implementations, computing resource 225 may host organizational management platform 220. The cloud resources may include compute instances executing in computing resource 225, storage devices provided in computing resource 225, data transfer devices provided by computing resource 225, etc. In some implementations, computing resource 225 may communicate with other computing resources 225 via wired connections, wireless connections, or a combination of wired and wireless connections.

As further shown in FIG. 2, computing resource 225 may include a group of cloud resources, such as one or more applications (“APPs”) 225-1, one or more virtual machines (“VMs”) 225-2, virtualized storage (“VSs”) 225-3, one or more hypervisors (“HYPs”) 225-4, or the like.

Application 225-1 includes one or more software applications that may be provided to or accessed by user device 210. Application 225-1 may eliminate a need to install and execute the software applications on user device 210. For example, application 225-1 may include software associated with organizational management platform 220 and/or any other software capable of being provided via cloud computing environment 230. In some implementations, one application 225-1 may send/receive information to/from one or more other applications 225-1, via virtual machine 225-2.

Virtual machine 225-2 includes a software implementation of a machine (e.g., a computer) that executes programs like a physical machine. Virtual machine 225-2 may be either a system virtual machine or a process virtual machine, depending upon use and degree of correspondence to any real machine by virtual machine 225-2. A system virtual machine may provide a complete system platform that supports execution of a complete operating system (“OS”). A process virtual machine may execute a single program, and may support a single process. In some implementations, virtual machine 225-2 may execute on behalf of a user (e.g., user device 210), and may manage infrastructure of cloud computing environment 230, such as data management, synchronization, or long-duration data transfers.

Virtualized storage 225-3 includes one or more storage systems and/or one or more devices that use virtualization techniques within the storage systems or devices of computing resource 225. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 225-4 provides hardware virtualization techniques that allow multiple operating systems (e.g., “guest operating systems”) to execute concurrently on a host computer, such as computing resource 225. Hypervisor 225-4 may present a virtual operating platform to the guest operating systems, and may manage the execution of the guest operating systems. Multiple instances of a variety of operating systems may share virtualized hardware resources.

Sensor device(s) 240 includes one or more devices capable of receiving, generating, storing, processing, and/or providing information, such as information described herein. For example, sensor device 240 may perform sensor measurements, and may provide information identifying the sensor measurements to organizational management platform 220. In some implementations, sensor device 240 may include a Bluetooth beacon, a proximity sensor, a motion sensor, a temperature sensor, a humidity sensor, a biometric sensor, a security sensor, and/or the like. For example, sensor device 240 may be a Bluetooth beacon that provides data identifying locations of user devices 210 in a facility of an organization to enable organizational management platform to provide social interaction information regarding users of user devices 210 to users in the facility. Similarly, sensor device 240 may be a temperature sensor that provides temperature data to organizational management platform 220 to enable organizational management platform to control a room temperature to a user's preference.

Data server(s) 250 includes one or more devices capable of storing, processing, and/or providing information, such as information described herein. For example, data server 250 may be an internal data server that provides data internal to the organization, such as employee data, project data, facilities data, and/or the like. Additionally, or alternatively, data server 250 may be an external data server that provides data external to the organization, such as weather data, flight data, restaurant data, activity data, and/or the like.

Network 260 includes one or more wired and/or wireless networks. For example, network 260 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

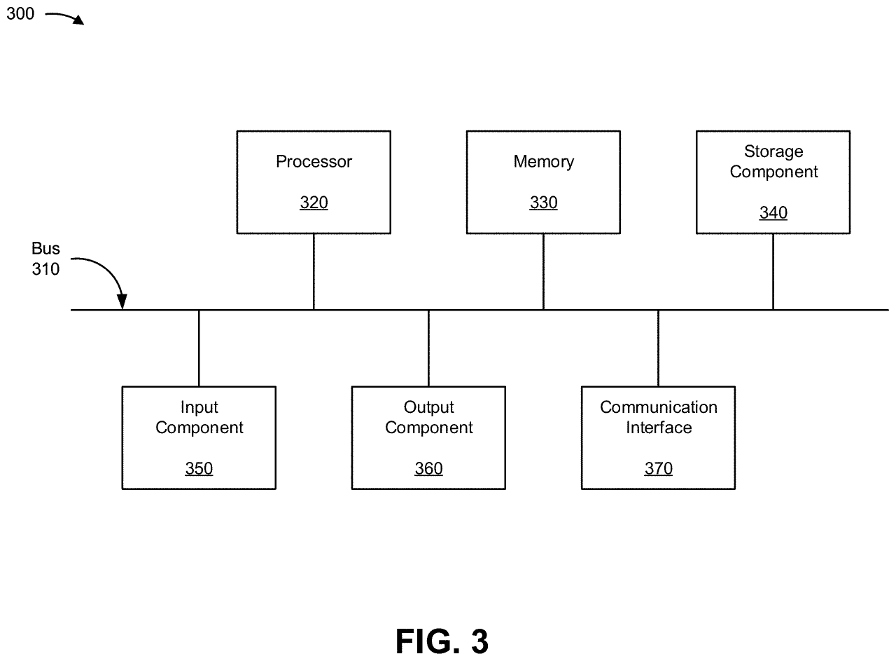

FIG. 3 is a diagram of example components of a device 300. Device 300 may correspond to user device 210, organizational management platform 220, computing resource 225, sensor device 240, and/or data server 250. In some implementations, user device 210, organizational management platform 220, computing resource 225, sensor device 240, and/or data server 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

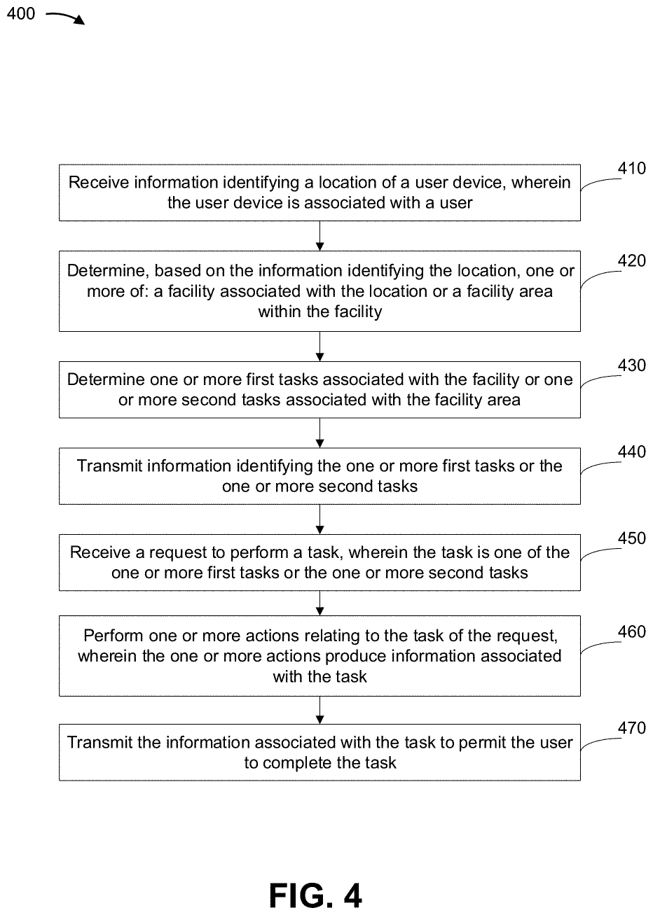

FIG. 4 is a flow chart of an example process 400 for contextual data processing and data distribution. In some implementations, one or more process blocks of FIG. 4 may be performed by an organizational management platform (e.g., organizational management platform 220). In some implementations, one or more process blocks of FIG. 4 may be performed by another device or a group of devices separate from or including the organizational management platform, such as a user device (e.g., user device 210), a sensor device (e.g., sensor device 240), a data server (e.g., data server 250), and/or the like.

As shown in FIG. 4, process 400 may include receiving information identifying a location of a user device, wherein the user device is associated with a user (block 410). For example, the organizational management platform (e.g., using computing resource 225, processor 320, memory 330, storage component 340, input component 350, communication interface 370, and/or the like) may receive information identifying a location of a user device, as described above. In some implementations, the user device may be associated with a user.

As further shown in FIG. 4, process 400 may include determining, based on the information identifying the location, one or more of a facility associated with the location or a facility area within the facility (block 420). For example, the organizational management platform (e.g., using computing resource 225, processor 320, memory 330, storage component 340, and/or the like) may determine, based on the information identifying the location, one or more of a facility associated with the location or a facility area within the facility, as described above.

As further shown in FIG. 4, process 400 may include determining one or more first tasks associated with the facility or one or more second tasks associated with the facility area (block 430). For example, the organizational management platform (e.g., using computing resource 225, processor 320, memory 330, storage component 340, and/or the like) may determine one or more first tasks associated with the facility or one or more second tasks associated with the facility area, as described above.

As further shown in FIG. 4, process 400 may include transmitting information identifying the one or more first tasks or the one or more second tasks (block 440). For example, the organizational management platform (e.g., using computing resource 225, processor 320, memory 330, storage component 340, output component 360, communication interface 370, and/or the like) may transmit information identifying the one or more first tasks or the one or more second tasks, as described above.

As further shown in FIG. 4, process 400 may include receiving a request to perform a task, wherein the task is one of the one or more first tasks or the one or more second tasks (block 450). For example, the organizational management platform (e.g., using computing resource 225, processor 320, memory 330, storage component 340, input component 350, communication interface 370, and/or the like) may receive a request to perform a task, as described above. In some implementations, the task is one of the one or more first tasks or the one or more second tasks.

As further shown in FIG. 4, process 400 may include performing one or more actions relating to the task of the request, wherein the one or more actions produce information associated with the task (block 460). For example, the organizational management platform (e.g., using computing resource 225, processor 320, memory 330, storage component 340, input component 350, output component 360, communication interface 370, and/or the like) may perform one or more actions relating to the task of the request, as described above. In some implementations, the one or more actions produce information associated with the task.

As further shown in FIG. 4, process 400 may include transmitting the information associated with the task to permit the user to complete the task (block 470). For example, the organizational management platform (e.g., using computing resource 225, processor 320, memory 330, storage component 340, output component 360, communication interface 370, and/or the like) may transmit the information associated with the task to permit the user to complete the task, as described above.

Process 400 may include additional implementations, such as any single implementation or any combination of implementations described below and/or in connection with one or more other processes described elsewhere herein.

In some implementations, the one or more first tasks associated with the facility may relate to one or more of accessing a secure location of the facility, accessing a feature of the facility, requesting support relating to a service of the facility, or locating an individual within the facility. In some implementations, the one or more second tasks associated with the facility area may relate to one or more of accessing the facility area, locating the facility area, adjusting an environmental setting of the facility area, or requesting support relating to a service of the facility area.

In some implementations, transmitting the information identifying the one or more first tasks or the one or more second tasks causes the user device to display a first user interface that identifies the one or more first tasks or a second user interface that identifies the one or more second tasks. In some implementations, the organizational management platform may determine information associated with the facility or information associated with the facility area, and transmit the information associated with the facility or the information associated with the facility area to the user device.

In some implementations, the task may be accessing the facility area, and when performing the one or more actions, the organizational management platform may determine available facility areas of the facility. The available facility areas may be determined based on sensor data, and the sensor data may identify a lack of an occupation of an available facility area. In some implementations, when performing the one or more actions, the organizational management platform may generate the information associated with the task, where the information associated with the task identifies the available facility areas to permit the user to select the facility area from the available facility areas.

In some implementations, the task may be locating the facility area. In some implementations, when performing the one or more actions, the organizational management platform may monitor the location of the user device in relation to the facility area and generate the information associated with the task, where the information associated with the task provides directional instructions to the facility area based on the location of the user device in relation to the facility area. In some implementations, when monitoring the location of the user device, the organizational management platform may monitor the location of the user device using one or more beacons located in the facility.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

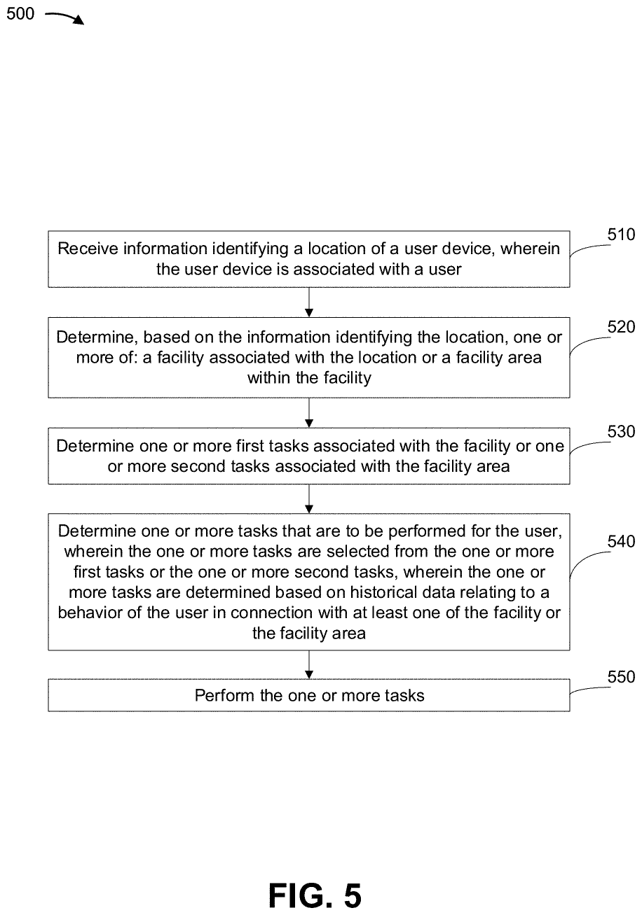

FIG. 5 is a flow chart of an example process 500 for contextual data processing and data distribution. In some implementations, one or more process blocks of FIG. 5 may be performed by an organizational management platform (e.g., organizational management platform 220). In some implementations, one or more process blocks of FIG. 5 may be performed by another device or a group of devices separate from or including the organizational management platform, such as a user device (e.g., user device 210), a sensor device (e.g., sensor device 240), a data server (e.g., data server 250), and/or the like.

As shown in FIG. 5, process 500 may include receiving information identifying a location of a user device, wherein the user device is associated with a user (block 510). For example, the organizational management platform (e.g., using computing resource 225, processor 320, memory 330, storage component 340, input component 350, communication interface 370, and/or the like) may receive information identifying a location of the user device, as described above. In some implementations, the user device may be associated with a user.

As further shown in FIG. 5, process 500 may include determining, based on the information identifying the location, one or more of a facility associated with the location or a facility area within the facility (block 520). For example, the organizational management platform (e.g., using computing resource 225, processor 320, memory 330, storage component 340, and/or the like) may determine, based on the information identifying the location, one or more of a facility associated with the location or a facility area within the facility, as described above.

As further shown in FIG. 5, process 500 may include determining one or more first tasks associated with the facility or one or more second tasks associated with the facility area (block 530). For example, the organizational management platform (e.g., using computing resource 225, processor 320, memory 330, storage component 340, and/or the like) may determine one or more first tasks associated with the facility or one or more second tasks associated with the facility area, as described above.

As further shown in FIG. 5, process 500 may include determining one or more tasks that are to be performed for the user, wherein the one or more tasks are selected from the one or more first tasks or the one or more second tasks, and wherein the one or more tasks are determined based on historical data relating to a behavior of the user in connection with at least one of the facility or the facility area (block 540). For example, the organizational management platform (e.g., using computing resource 225, processor 320, memory 330, storage component 340, and/or the like) may determine one or more tasks that are to be performed for the user, as described above. In some implementations, the one or more tasks may be selected from the one or more first tasks or the one or more second tasks. In some implementations, the one or more tasks may be determined based on historical data relating to a behavior of the user in connection with at least one of the facility or the facility area.

As further shown in FIG. 5, process 500 may include performing the one or more tasks (block 550). For example, the organizational management platform (e.g., using computing resource 225, processor 320, memory 330, storage component 340, input component 350, output component 360, communication interface 370, and/or the like) may perform the one or more tasks, as described above.

Process 500 may include additional implementations, such as any single implementation or any combination of implementations described below and/or in connection with one or more other processes described elsewhere herein.

In some implementations, the organizational management platform may determine a geographic area that contains the facility and determine one or more third tasks associated with the geographic area. In some implementations, the one or more tasks may be selected from the one or more first tasks, the one or more second tasks, or the one or more third tasks. In some implementations, the one or more tasks may be determined based on historical data relating to a behavior of the user in connection with at least one of the facility, the geographic area, or the facility area.

In some implementations, performing the one or more tasks may produce information associated with the one or more tasks, and the organizational management platform may transmit the information associated with the one or more tasks to the user device. In some implementations, the organizational management platform may determine information associated with the facility or information associated with the facility area and transmit the information associated with the facility or the information associated with the facility area to the user device.

In some implementations, the behavior of the user may relate to one or more previous tasks requested by the user relating to the facility or the facility area and/or one or more previous locations of the user device within the facility or the facility area. In some implementations, the historical data may be first historical data, and when determining the one or more tasks, the organizational management platform may determine the one or more tasks based on the first historical data and second historical data relating to behaviors of a plurality of users in connection with at least one of the facility or the facility area. In some implementations, the user may share one or more characteristics with the plurality of users.

In some implementations, the task may be reserving a particular facility area, and the organizational management platform may determine that the user device is present in the particular facility area and transmit information associated with the particular facility area to the user device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

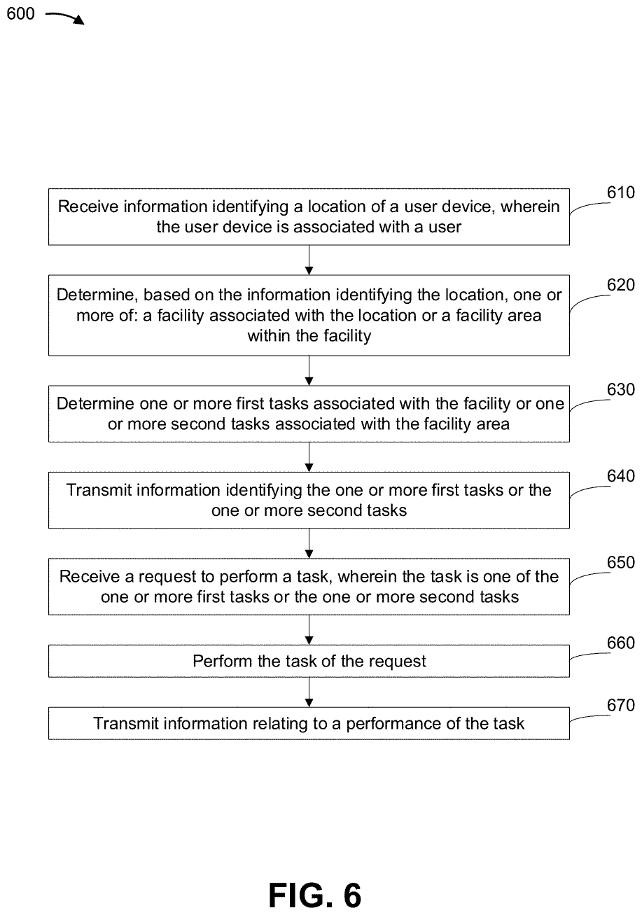

FIG. 6 is a flow chart of an example process 600 for contextual data processing and data distribution. In some implementations, one or more process blocks of FIG. 6 may be performed by an organizational management platform (e.g., organizational management platform 220). In some implementations, one or more process blocks of FIG. 6 may be performed by another device or a group of devices separate from or including the organizational management platform, such as a user device (e.g., user device 210), a sensor device (e.g., sensor device 240), a data server (e.g., data server 250), and/or the like.

As shown in FIG. 6, process 600 may include receiving information identifying a location of a user device, wherein the user device is associated with a user (block 610). For example, the organizational management platform (e.g., using computing resource 225, processor 320, memory 330, storage component 340, input component 350, communication interface 370, and/or the like) may receive information identifying a location of the user device, as described above. In some implementations, the user device may be associated with a user.

As further shown in FIG. 6, process 600 may include determining, based on the information identifying the location, one or more of a facility associated with the location or a facility area within the facility (block 620). For example, the organizational management platform (e.g., using computing resource 225, processor 320, memory 330, storage component 340, and/or the like) may determine, based on the information identifying the location, one or more of a facility associated with the location or a facility area within the facility, as described above.

As further shown in FIG. 6, process 600 may include determining one or more first tasks associated with the facility or one or more second tasks associated with the facility area (block 630). For example, the organizational management platform (e.g., using computing resource 225, processor 320, memory 330, storage component 340, and/or the like) may determine one or more first tasks associated with the facility or one or more second tasks associated with the facility area, as described above.

As further shown in FIG. 6, process 600 may include transmitting information identifying the one or more first tasks or the one or more second tasks (block 640). For example, the organizational management platform (e.g., using computing resource 225, processor 320, memory 330, storage component 340, output component 360, communication interface 370, and/or the like) may transmit information identifying the one or more first tasks or the one or more second tasks, as described above.

As further shown in FIG. 6, process 600 may include receiving a request to perform a task, wherein the task is one of the one or more first tasks or the one or more second tasks (block 650). For example, the organizational management platform (e.g., using processor 320, memory 330, storage component 340, input component 350, communication interface 370, and/or the like) may receive a request to perform a task, as described above. In some implementations, the task may be one of the one or more first tasks or the one or more second tasks.

As further shown in FIG. 6, process 600 may include performing the task of the request (block 660). For example, the organizational management platform (e.g., using computing resource 225, processor 320, memory 330, storage component 340, input component 350, output component 360, communication interface 370, and/or the like) may perform the task of the request, as described above.

As further shown in FIG. 6, process 600 may include transmitting information relating to a performance of the task (block 670). For example, the organizational management platform (e.g., using processor 320, memory 330, storage component 340, output component 360, communication interface 370, and/or the like) may transmit information relating to a performance of the task, as described above.

Process 600 may include additional implementations, such as any single implementation or any combination of implementations described below and/or in connection with one or more other processes described elsewhere herein.

In some implementations, the one or more first tasks associated with the facility may relate to one or more of generating a credential to access a secure location of the facility, initiating a support request relating to a service of the facility, or locating an individual within the facility. In some implementations, the one or more second tasks associated with the facility may relate to one or more of reserving the facility area, generating instructions for locating the facility area, adjusting an environmental setting of the facility area, or initiating a support request relating to a service of the facility area.

In some implementations, transmitting the information identifying the one or more first tasks or the one or more second tasks may cause the user device to display a first user interface that identifies the one or more first tasks or a second user interface that identifies the one or more second tasks. In some implementations, the organizational management platform may determine information associated with the facility or information associated with the facility area and transmit the information associated with the facility or the information associated with the facility area to the user device.

In some implementations, the task may be generating a credential to access a secure location of the facility, and when performing the task of the request, the organizational management platform may determine an authorization of the user based on an identity of the user, generate, based on determining the authorization, the credential that permits the user to access the secure location, and transmit the credential to the user device.

In some implementations, the organizational management platform may determine one or more tasks that are to be performed for the user, where the one or more tasks are selected from the one or more first tasks or the one or more second tasks. In some implementations, the one or more tasks may be determined based on historical data relating to a behavior of the user in connection with at least one of the facility or the facility area. In some implementations, the organizational management platform may perform the one or more tasks.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device and from a user device, information identifying a location of the user device,
wherein the user device is associated with a user;
determining, by the device and based on the information identifying the location, one or more of:
a facility associated with the location, or
a facility area within the facility;
determining, by the device, one or more first tasks associated with the facility or one or more second tasks associated with the facility area;
transmitting, by the device and to the user device, information identifying the one or more first tasks or the one or more second tasks;
receiving, by the device and from the user device, a request to perform a task,
wherein the task is one of the one or more first tasks or the one or more second tasks;
performing, by the device, one or more actions relating to the task of the request,
wherein the one or more actions produce information associated with the task; and
transmitting, by the device and to the user device, the information associated with the task to permit the user to complete the task.

2. The method of claim 1, wherein the one or more first tasks associated with the facility relate to one or more of accessing a secure location of the facility, accessing a feature of the facility, requesting support relating to a service of the facility, or locating an individual within the facility,
wherein the one or more second tasks associated with the facility area relate to one or more of accessing the facility area, locating the facility area, adjusting an environmental setting of the facility area, or requesting support relating to a service of the facility area.

3. The method of claim 1, wherein transmitting the information identifying the one or more first tasks or the one or more second tasks causes the user device to display a first user interface that identifies the one or more first tasks or a second user interface that identifies the one or more second tasks.

4. The method of claim 1, further comprising:
determining information associated with the facility or information associated with the facility area; and
transmitting the information associated with the facility or the information associated with the facility area to the user device.

5. The method of claim 1, wherein the task is accessing the facility area,
wherein performing the one or more actions comprises:
determining available facility areas of the facility,
wherein the available facility areas are determined based on sensor data,
wherein the sensor data identifies a lack of an occupation of an available facility area; and
generating the information associated with the task,
wherein the information associated with the task identifies the available facility areas to permit the user to select the facility area from the available facility areas.

6. The method of claim 1, wherein the task is locating the facility area, wherein performing the one or more actions comprises:
monitoring the location of the user device in relation to the facility area; and
generating the information associated with the task,
wherein the information associated with the task provides directional instructions to the facility area based on the location of the user device in relation to the facility area.

7. The method of claim 6, wherein monitoring the location of the user device comprises:
monitoring the location of the user device using one or more beacons located in the facility.

8. A device, comprising:
one or more memories; and
one or more processors, communicatively coupled to the one or more memories, to:
receive, from a user device, information identifying a location of the user device,
wherein the user device is associated with a user;
determine, based on the information identifying the location, one or more of:
a facility associated with the location, or
a facility area within the facility;
determine one or more first tasks associated with the facility or one or more second tasks associated with the facility area;
determine one or more tasks that are to be performed for the user,
wherein the one or more tasks are selected from the one or more first tasks or the one or more second tasks,
wherein the one or more tasks are determined based on historical data relating to a behavior of the user in connection with at least one of the facility or the facility area; and
perform the one or more tasks.

9. The device of claim 8, wherein the one or more processors are further to:
determine a geographic area that contains the facility; and
determine one or more third tasks associated with the geographic area,
wherein the one or more tasks are selected from the one or more first tasks, the one or more second tasks, or the one or more third tasks,
wherein the one or more tasks are determined based on historical data relating to a behavior of the user in connection with at least one of the facility, the geographic area, or the facility area.

10. The device of claim 8, wherein performing the one or more tasks produces information associated with the one or more tasks,
wherein the one or more processors are further to:
transmit the information associated with the one or more tasks to the user device.

11. The device of claim 8, wherein the one or more processors are further to:
determine information associated with the facility or information associated with the facility area; and
transmit the information associated with the facility or the information associated with the facility area to the user device.

12. The device of claim 8, wherein the behavior of the user relates one or more of:
one or more previous tasks requested by the user relating to the facility or the facility area, or
one or more previous locations of the user device within the facility or the facility area.

13. The device of claim 8, wherein the historical data is a first historical data, wherein the one or more processors, when determining the one or more tasks, are to:
determine the one or more tasks based on the first historical data and second historical data relating to behaviors of a plurality of users in connection with at least one of the facility or the facility area,
wherein the user shares one or more characteristics with the plurality of users.

14. The device of claim 8, wherein the one or more tasks include reserving a particular facility area,
wherein the one or more processors are further to:
determine that the user device is present in the particular facility area; and
transmitting information associated with the particular facility area to the user device.

15. A non-transitory computer-readable medium storing instructions, the instructions comprising:
one or more instructions that, when executed by one or more processors, cause the one or more processors to:
receive, from a user device, information identifying a location of the user device,
wherein the user device is associated with a user;
determine, based on the information identifying the location, one or more of:
a facility associated with the location, or
a facility area within the facility;
determine one or more first tasks associated with the facility or one or more second tasks associated with the facility area;
transmit, to the user device, information identifying the one or more first tasks or the one or more second tasks;
receive, from the user device, a request to perform a task,
wherein the task is one of the one or more first tasks or the one or more second tasks;
perform the task of the request; and
transmit, to the user device, information relating to a performance of the task.

16. The non-transitory computer-readable medium of claim 15, wherein the one or more first tasks associated with the facility relate to one or more of generating a credential to access a secure location of the facility, initiating a support request relating to a service of the facility, or locating an individual within the facility,
wherein the one or more second tasks associated with the facility area relate to one or more of reserving the facility area, generating instructions for locating the facility area, adjusting an environmental setting of the facility area, or initiating a support request relating to a service of the facility area.

17. The non-transitory computer-readable medium of claim 15, wherein transmitting the information identifying the one or more first tasks or the one or more second tasks causes the user device to display a first user interface that identifies the one or more first tasks or a second user interface that identifies the one or more second tasks.

18. The non-transitory computer-readable medium of claim 15, wherein the one or more instructions, when executed by the one or more processors, further cause the one or more processors to:
determine information associated with the facility or information associated with the facility area; and
transmit the information associated with the facility or the information associated with the facility area to the user device.

19. The non-transitory computer-readable medium of claim 15, wherein the task is generating a credential to access a secure location of the facility,
wherein the one or more instructions, that cause the one or more processors to perform the task of the request, cause the one or more processors to:
determine an authorization of the user based on an identity of the user;
generate, based on determining the authorization, the credential that permits the user to access the secure location; and
transmitting the credential to the user device.

20. The non-transitory computer-readable medium of claim 15, wherein the one or more instructions, when executed by the one or more processors, further cause the one or more processors to:
determine one or more tasks that are to be performed for the user,
wherein the one or more tasks are selected from the one or more first tasks or the one or more second tasks,
wherein the one or more tasks are determined based on historical data relating to a behavior of the user in connection with at least one of the facility or the facility area; and perform the one or more tasks.
